(19) United States
(12) Patent Application Publication
(10) Pub. No.: US 2017/0147206 A1
(43) Pub. Date: May 25, 2017

(54) SIGNAL SAMPLING METHOD AND SENSING SYSTEM

(71) Applicant: PixArt Imaging Inc., Hsin-Chu City (TW)

(72) Inventor: Chia-Yi Lee, Hsin-Chu City (TW)

(21) Appl. No.: 15/298,215

(22) Filed: Oct. 19, 2016

(30) Foreign Application Priority Data
Nov. 23, 2015 (TW) 104138844

(51) Int. Cl. G06F 3/05; G06F 3/044

(52) U.S. Cl. CPC G06F 3/05; G06F 3/044

(57) ABSTRACT

A signal sampling method, applied to a sensing system comprising a sensing matrix with a first sensing region and a second sensing region. The signal sampling method comprises: (a) applying a first single period sampling number to sample a sensing value of the first sensing region to generate a first sensing signal; and (b) applying a second single period sampling number to sample a sensing value of the second sensing region to generate a second sensing signal. The values of the first single period sampling number and the second single period sampling number are different. The selection for the single period sampling number is extended via sampling different sensing regions by different single period sampling numbers.

### BACKGROUND OF THE INVENTION

1. Field of the Invention

The present invention relates to a signal sampling method and a sensing system, and particularly relates to a signal sampling method and a sensing system which apply different single period sampling numbers to different sensing regions.

2. Description of the Prior Art

A conventional capacitive sensing apparatus always comprises a capacitive sensing matrix. Each capacitive sensing matrix comprises a plurality of sensing regions, for example, cells. Traditionally, detecting signals generated by the sensing regions are sampled by the same single period sampling number. The term single period sampling number means a sampling number for a fixed time period, for example, 100 times per second. However, different sensing regions may have different states. Accordingly, it is improper to apply the same single period sampling number for different sensing regions. Also, such method may limit the selection of the single period sampling number.

For example, if the capacitive sensing apparatus is applied to a touch control screen, the single period sampling number is limited by a frame rate. A controller in the capacitive sensing apparatus, for example, a DSP (digital signal processing circuit), does not process data until complete data of a frame is received while receiving data from an analog to digital converter. Also, the number for the frames that the controller processes per second must meet a requirement for a minimum number. Accordingly, the selection of the single period sampling number is limited by such minimum number. Furthermore, some single period sampling numbers are not suitable for some sensing regions, thus the selection of the single period sampling number is further limited.

### SUMMARY OF THE INVENTION

Therefore, one objective of the present application is to provide a signal sampling method which can apply different single period sampling numbers to sample sensing values for different sensing regions.

Another objective of the present application is to provide a signal sampling system which can apply different single period sampling numbers to sample sensing values for different sensing regions.

On embodiment of the present application provides a signal sampling method applied to a sensing system comprising a sensing matrix comprising a first sensing region and a second sensing region. The signal sampling method comprises: (a) applying a first single period sampling number to sample sensing values of the first sensing region to generate a first sensing signal; (b) applying a second single period sampling number to sample sensing values of the second sensing region to generate a second sensing signal. The first single period sampling number and the second single period sampling number have different values.

Another embodiment of the present application provides a sensing system comprising a sensing matrix comprising a first sensing region and a second sensing region; a sampling apparatus; and a controller. The controller is configured to perform following steps: (a) controlling the sampling apparatus to apply a first single period sampling number to sample sensing values of the first sensing region to generate a first sensing signal; (b) controlling the sampling apparatus to apply a second single period sampling number to sample sensing values of the second sensing region to generate a second sensing signal. The first single period sampling number and the second single period sampling number have different values.

In view of above-mentioned embodiments, the present invention can apply different single period sampling numbers to sample different sensing regions. According, the conventional issue that the selection for the single period sampling number is limited can be solved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a capacitive sensing system according to one embodiment of the present invention.

FIG. 2 is a block diagram illustrating a capacitive sensing system according to another embodiment of the present invention.

FIG. 3 is an example for the detail structure of the embodiments illustrated in FIG. 1 and FIG. 2.

FIG. 4 is a block diagram illustrating a capacitive sensing system according to another embodiment of the present invention.

### DETAILED DESCRIPTION

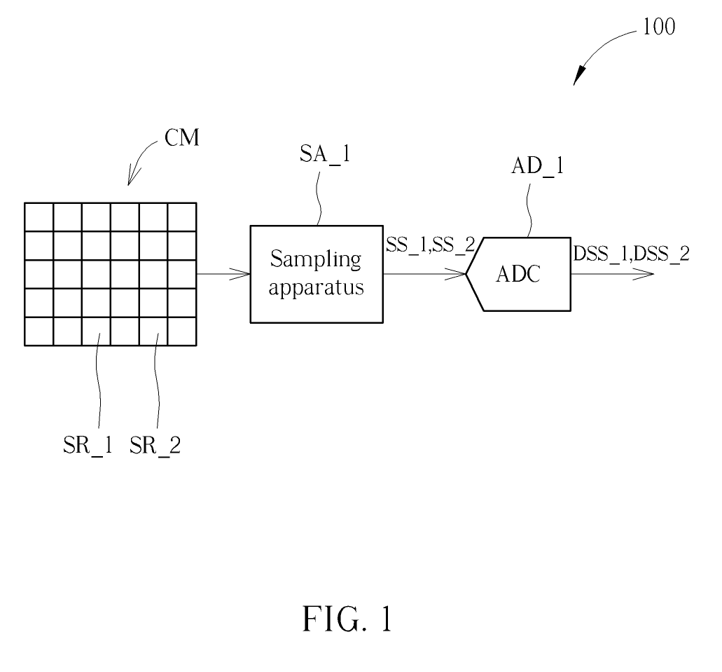

FIG. 1 is a block diagram illustrating a capacitive sensing system according to one embodiment of the present invention. As illustrated in FIG. 1, the capacitive sensing system 100 comprises a capacitive sensing matrix CM, a first sampling apparatus SA_1 and a first analog to digital converter AD_1. The capacitive sensing matrix CM comprises a plurality of capacitive sensing units. However, in this embodiment, only the first capacitive sensing unit SR_1 and second capacitive sensing unit SR_2 are illustrated. The first sampling apparatus SA_1 applies a first single period sampling number to sample capacitance values of the first capacitive sensing unit SR_1 to generate a first sensing signal SS_1. Also, the first sampling apparatus SA_1 applies a second single period sampling number to sample capacitance values of the second capacitive sensing unit SR_2 to generate a second sensing signal SS_2. That is, the first sampling apparatus SA_1 can apply different single period sampling numbers to sample capacitance values for different capacitive sensing units to generate sensing signals. However, a conventional capacitive sensing system uses the same single period sampling number to sample the whole capacitive sensing matrix CM. The first analog to digital converter AD_1 is configured to convert the first sensing signal SS_1 and the second sensing signal SS_2 to a first digital sensing signal DSS_1 and a second digital sensing signal DSS_2.

For the convenience for explaining, different single period sampling numbers are respectively applied to different capacitive sensing units in above-mentioned embodiments. However, in another embodiment, a plurality of capacitive sensing units are combined to a single sensing region which applies the same single period sampling number. Therefore, in such embodiment, different single period sampling numbers are respectively applied to different sensing regions.

Many methods can be applied to decide values for a first single period sampling number and a second single period sampling number. In one embodiment, the device characteristics (ex. durability or sensitivity for voltage variation) of the first capacitive sensing unit SR_1 and second capacitive sensing unit SR_2 are detected. After that, the first single period sampling number and the second single period sampling number are set according to the device characteristics of the first capacitive sensing unit SR_1 and second capacitive sensing unit SR_2.

The capacitive sensing units of the capacitive sensing matrix CM may have different noise disturbance levels or different anti-noise levels due to the process issue, the hardware defect or other factors. Therefore, the “over-sampling” number can be raised if the capacitive sensing units have a high noise disturbance levels or a low anti-noise level, thereby the qualities for sampled sensing values can be increased. That is, the single period sampling numbers for these capacitive sensing units or corresponding sensing regions can be increased to improve the qualities for sampled sensing values.

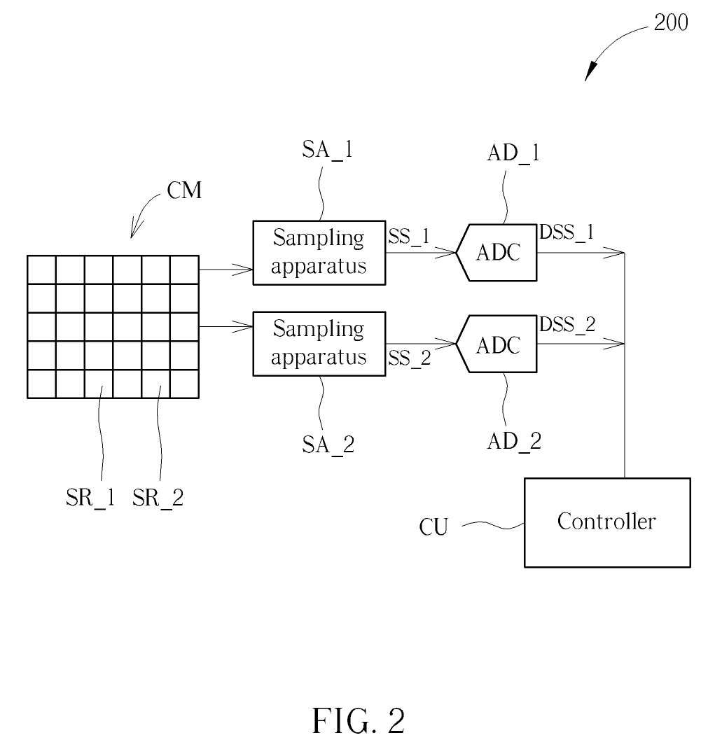

Please note, the embodiment illustrated in FIG. 1 only applies one sampling apparatus and one analog to digital converter. However, the present invention is not limited to apply only one sampling apparatus and only one analog to digital converter. Please refer to FIG. 2, the capacitive sensing system 200 further comprises a second sampling apparatus SA_2 and a second analog to digital converter AD_2 besides the first sampling apparatus SA_1 and the first analog to digital converter AD_1. That is, the capacitive sensing system 200 comprises more than one combination of a sampling apparatus and an analog to digital converter. These sampling apparatuses and analog to digital converters are respectively applied to process different capacitive sensing units. In one embodiment, the same analog to digital converter receives sensing signals from capacitive units of the same row or the same column, but not limited.

For more detail, in the embodiment of FIG. 2, the first sampling apparatus SA_1 is applied to sample capacitance values of the first capacitive sensing unit SR_1 to generate a first sensing signal SS_1. Also, the second sampling apparatus SA_2 is applied to sample capacitance values of the second capacitive sensing unit SR_2 to generate a second sensing signal SS_2. The first analog to digital converter AD_1 is applied to generate a first digital sensing signal DSS_1 according to the first sensing signal SS_1, and the second analog to digital converter AD_2 is applied to generate a second digital sensing signal DSS_2 according to the second sensing signal SS_2. In one embodiment, after the second analog to digital converter AD_2 generates the second digital sensing signal DSS_2, the second analog to digital converter AD_2 does not output the second digital sensing signal DSS_2 to the controller CU until the first analog to digital converter AD_1 generates the first digital sensing signal DSS_1. That is, the analog to digital converter corresponding to a smaller single period sampling number does not output the digital sensing signal to the controller CU until the analog to digital converter corresponding to a larger single period sampling number generates the sensing signal. The controller is hardware or a combination of hardware and software which can perform logic operations, such as a digital signal processor (DSP) or a central processing unit (CPU). In one embodiment, the analog to digital converter corresponding to a smaller single period sampling number also samples sensing signals while waiting for the analog to digital converter corresponding to a larger single period sampling number. By this way, the processing time for analog to digital converters corresponding to different single period sampling numbers can be synchronized.

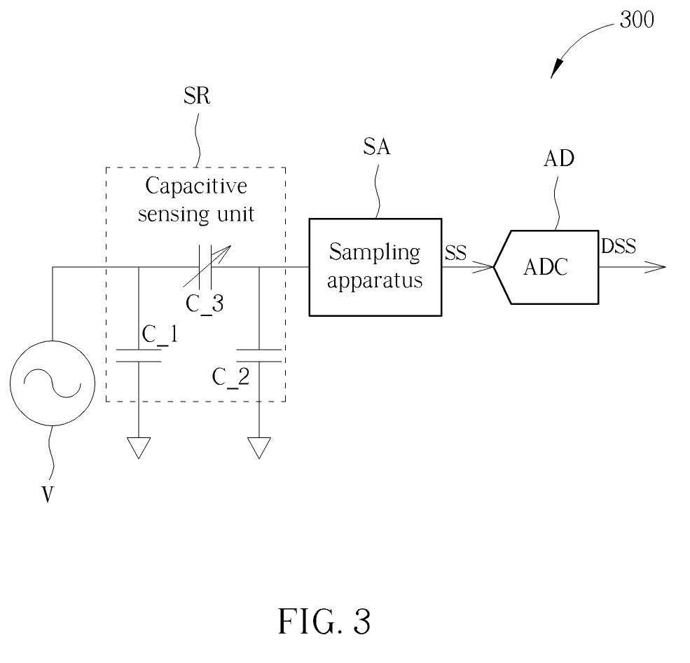

The above-mentioned capacitive sensing unit can comprise various structures. FIG. 3 is an example for the detail structure of the embodiments illustrated in FIG. 1 and FIG. 2. As illustrated in FIG. 3, the capacitive unit SR is coupled to a voltage source V and comprises a plurality of capacitors C_1, C_2, C_3. The voltage source V is configured to charge the capacitors C_1, C_2, C_3, and the sampling apparatus SA samples equivalent capacitance values of the capacitors C_1, C_2, C_3. Then, the accumulated sampling values are output to the analog to digital converter ADC after the sampling number reaches a predetermined value (i.e. the above-mentioned single period sampling number). The capacitance value of the capacitive sensing unit SR changes if a distance between an object (ex. a finger) and the capacitive sensing unit SR is smaller than a predetermined value. By this way, it can be determined that if any object touches or approaches the capacitive sensing matrix. However, persons skilled in the art can understand that the capacitive sensing unit SR can comprise various structures, which have different connections to the sampling circuit and the analog to digital converter. For example, a US patent with a patent number U.S. Pat. No. 8,970,230 discloses a capacitive sensing circuit which has a structure different from the structure illustrated in FIG. 3 of the present invention. Therefore, persons skilled in the art can understand that the concept of the present invention can be applied to capacitive sensing circuits with different structures.

It should be noted that, the method for controlling the single period sampling numbers to capacitive sensing units is not limited to above-mentioned method, which means controlling the single period sampling number for a corresponding capacitive sensing unit via the first sampling apparatus SA_1. In one embodiment, the driving part (not illustrated) of the capacitance sensing matrix CM is applied to control single period sampling numbers for capacitive sensing units. For example, adjust a frequency of a driving signal to change the single period sampling number. It will be appreciated that other methods for controlling at least one single period sampling number for at least one capacitive sensing units can be applied to the present application as well.

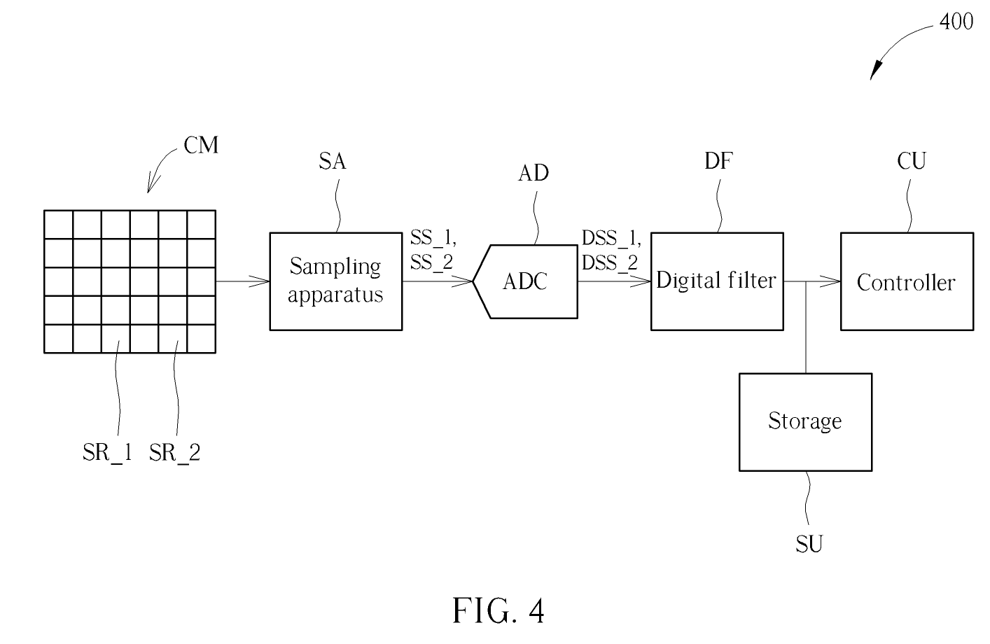

The above-mentioned embodiments change the single period sampling number before the analog to digital converter processes the sensing signal. However, the sampling number for the analog to digital converter itself can also be changed to reach the same effect. FIG. 4 is a block diagram illustrating a capacitive sensing system according to another embodiment of the present invention. In the embodiment of FIG. 4, the capacitive sensing system 400 also comprises a capacitive sensing matrix CM, a sampling apparatus SA, and an analog to digital converter AD. In this embodiment, the sampling apparatus SA applies the same single period sampling number to sample capacitance values of the first capacitive sensing unit SR_1 and the second capacitive sensing unit SR_2 to generate a first sensing signal SS_1 and a second sensing signal SS_2. However, this embodiment can apply different single period sampling numbers such as above-mentioned embodiments. Afterwards, the analog to digital converter AD applies different sampling frequencies to digitalize the first sensing signal SS_1 and the second sensing signal SS_2, to generate the first digital sensing signal DSS_1 and the second digital sensing signal DSS_2. By this way, the effect for applying different single period sampling numbers to sample capacitance values of different capacitance sensing units can be reached.

In one embodiment, the capacitive sensing system 400 further comprises a digital filter DF. Such digital filter DF filters the digital sensing signal output from the analog to digital converter AD, and then the remained sensing data is stored to the storage SU (ex. a buffer). After that, the controller CU computes the sensing data stored in the storage SU.

Please note the above-mentioned embodiments can be combined. For example, the embodiment in FIG. 4 can comprise more than one combinations of a sampling apparatus and an analog to digital converter as illustrated in FIG. 2. Also, the above-mentioned embodiments are not limited to simultaneously comprise a sampling apparatus and an analog to digital converter. Take the embodiment in FIG. 1 for example, if the first analog to digital converter is removed, the first sensing signal SS_1 and the second sensing signal SS_2 are not digitalized by the first analog to digital converter AD_1. Such combination and variation should fall in the scope of the present application.

Furthermore, the above-mentioned embodiments can be applied to other kinds of sensing systems rather than limited a capacitive sensing matrix. That is, the sampling apparatus can sample a sensing signal which is generated from a sensing matrix other than a capacitive sensing matrix. Accordingly, the sensing system provided by the present application can be summarized as follows: A sensing system, comprising: a sensing matrix, comprising a first sensing region and a second sensing region; a sampling apparatus; and a controller. The sensing matrix can be the above-mentioned capacitive sensing matrix, or other kind of sensing matrix, for example, an optical sensing matrix. The controller is configured to perform following steps: (a) controlling the sampling apparatus to apply a first single period sampling number to sample sensing values of the first sensing region to generate a first sensing signal; (b) controlling the sampling apparatus to apply a second single period sampling number to sample sensing values of the second sensing region to generate a second sensing signal. The first single period sampling number and the second single period sampling number have different values. Please note the sensing matrix means a sensing device or a sensing apparatus comprising a plurality of sensing regions, thus are is not limited to have a structure of “matrix”.

In view of above-mentioned embodiments, a signal sampling method applied to a sensing system comprising a sensing matrix comprising a first sensing region and a second sensing region can be acquired. The signal sampling method comprises: (a) applying a first single period sampling number to sample sensing values of the first sensing region to generate a first sensing signal; (b) applying a second single period sampling number to sample sensing values of the second sensing region to generate a second sensing signal. The first single period sampling number and the second single period sampling number have different values.

In view of above-mentioned embodiments, the present invention can apply different single period sampling numbers to sample different sensing regions. According, the conventional issue that the selection for the single period sampling number is limited can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signal sampling method, applied to a sensing system comprising a sensing matrix comprising a first sensing region and a second sensing region, wherein the signal sampling method comprises:
(a) applying a first single period sampling number to sample sensing values of the first sensing region to generate a first sensing signal;
(b) applying a second single period sampling number to sample sensing values of the second sensing region to generate a second sensing signal;
wherein the first single period sampling number and the second single period sampling number have different values.

2. The signal sampling method of claim 1,
wherein the sensing matrix is a capacitive sensing matrix;
wherein the sensing system comprises a first capacitive sensing unit and a second capacitive sensing unit;
wherein the step (a) comprises: applying the first single period sampling number to sample capacitance values of the first capacitive sensing unit to generate the first sensing signal;
wherein the step (b) comprises: applying the second single period sampling number to sample capacitance values of the second capacitive sensing unit to generate the second sensing signal.

3. The signal sampling method of claim 2,
wherein the first sensing signal and the second sensing signal are analog signals, wherein the first single period sampling number is larger than the second single period sampling number;
wherein the sensing system further comprises a first analog to digital converter, configured to generate a first digital sensing signal according to the first sensing signal;
wherein the sensing system further comprises a second analog to digital converter, configured to generate a second digital sensing signal according to the second sensing signal;
wherein, after the second analog to digital converter generates the second digital sensing signal, the second analog to digital converter does not output the second digital sensing signal until the first analog to digital converter generates the first digital sensing signal.

4. The signal sampling method of claim 2, further comprising:
detecting device characteristics of the first capacitive sensing unit and the second capacitive sensing unit; and
setting the first single period sampling number and the second single period sampling number according to the device characteristics of the first capacitive sensing unit and the second capacitive sensing unit.

5. The signal sampling method of claim 4,
wherein the first sensing signal and the second sensing signal are analog signals;
wherein the sensing system further comprises a first analog to digital converter and a second analog to digital converter;
wherein the step (a) further comprises applying the first analog to digital converter to utilize a third single period sampling number to sample the first sensing signal to generate a first digital sensing signal;
wherein the step (b) further comprises applying the second analog to digital converter to utilize a fourth single period sampling number to sample the second sensing signal to generate a second digital sensing signal;
wherein the third single period sampling number and the fourth single period sampling number have different values.

6. The signal sampling method of claim 5,
wherein the third single period sampling number is larger than the fourth single period sampling number;
wherein, after the second analog to digital converter generates the second digital sensing signal, the second analog to digital converter does not output the second digital sensing signal until the first analog to digital converter generates the first digital sensing signal.

7. The signal sampling method of claim 5, further comprising:
detecting device characteristics of the first analog to digital converter and the second analog to digital converter; and
setting the third single period sampling number and the fourth single period sampling number according to the device characteristics of the first analog to digital converter and the second analog to digital converter.

8. The signal sampling method of claim 1,
wherein the first sensing signal and the second sensing signal are digital signals;
wherein the sensing system further comprises a first analog to digital converter and a second analog to digital converter;
wherein the step (a) further comprises applying the first analog to digital converter to utilize the first single period sampling number to sample a first analog signal to generate the first sensing signal;
wherein the step (b) further comprises applying the second analog to digital converter to utilize the second single period sampling number to sample a second analog signal to generate the second sensing signal.

9. The signal sampling method of claim 8,
wherein the first single period sampling number is larger than the second single period sampling number;
wherein, after the second analog to digital converter generates the second digital sensing signal, the second analog to digital converter does not output the second digital sensing signal until the first analog to digital converter generates the first digital sensing signal.

10. The signal sampling method of claim 8, further comprising:
detecting device characteristics of the first analog to digital converter and the second analog to digital converter; and
setting the first single period sampling number and the second single period sampling number according to the device characteristics of the first analog to digital converter and the second analog to digital converter.

11. A sensing system, comprising:
a sensing matrix, comprising a first sensing region and a second sensing region;
a sampling apparatus; and
a controller, configured to perform following steps:
(a) controlling the sampling apparatus to apply a first single period sampling number to sample sensing values of the first sensing region to generate a first sensing signal;
(b) controlling the sampling apparatus to apply a second single period sampling number to sample sensing values of the second sensing region to generate a second sensing signal;
wherein the first single period sampling number and the second single period sampling number have different values.

12. The sensing system of claim 11,
wherein the first sensing signal and the second sensing signal are analog signals, wherein the first single period sampling number is larger than the second single period sampling number;
wherein the sensing system further comprises a first analog to digital converter, configured to generate a first digital sensing signal according to the first sensing signal;
wherein the sensing system further comprises a second analog to digital converter, configured to generate a second digital sensing signal according to the second sensing signal;
wherein, after the second analog to digital converter generates the second digital sensing signal, the second analog to digital converter does not output the second digital sensing signal until the first analog to digital converter generates the first digital sensing signal.

13. The sensing system of claim 11,
wherein the sensing matrix is a capacitive sensing matrix;
wherein the sensing system comprises a first capacitive sensing unit and a second capacitive sensing unit;
wherein the step (a) comprises: applying the first single period sampling number to sample capacitance values of the first capacitive sensing unit to generate the first sensing signal;
wherein the step (b) comprises: applying the second single period sampling number to sample capacitance values of the second capacitive sensing unit to generate the second sensing signal.

14. The sensing system of claim 13, wherein the controller is further configured to performs following steps:
detecting device characteristics of the first capacitive sensing unit and the second capacitive sensing unit; and
setting the first single period sampling number and the second single period sampling number according to the device characteristics of the first capacitive sensing unit and the second capacitive sensing unit.

15. The sensing system of claim 14,
wherein the first sensing signal and the second sensing signal are analog signals;
wherein the sensing system further comprises a first analog to digital converter and a second analog to digital converter;
wherein the step (a) further comprises applying the first analog to digital converter to utilize a third single period sampling number to sample the first sensing signal to generate a first digital sensing signal;
wherein the step (b) further comprises applying the second analog to digital converter to utilize a fourth single period sampling number to sample the second sensing signal to generate a second digital sensing signal;
wherein the third single period sampling number and the fourth single period sampling number have different values.

16. The sensing system of claim 15,
wherein the third single period sampling number is larger than the fourth single period sampling number;
wherein, after the second analog to digital converter generates the second digital sensing signal, the second analog to digital converter does not output the second digital sensing signal until the first analog to digital converter generates the first digital sensing signal.

17. The sensing system of claim 15, wherein the controller is further configured to performs following steps:
detecting device characteristics of the first analog to digital converter and the second analog to digital converter; and
setting the third single period sampling number and the fourth single period sampling number according to the device characteristics of the first analog to digital converter and the second analog to digital converter.

18. The sensing system of claim 11,
wherein the first sensing signal and the second sensing signal are digital signals;
wherein the sensing system further comprises a first analog to digital converter and a second analog to digital converter;
wherein the step (a) further comprises applying the first analog to digital converter to utilize the first single period sampling number to sample a first analog signal to generate the first sensing signal;
wherein the step (b) further comprises applying the second analog to digital converter to utilize the second single period sampling number to sample a second analog signal to generate the second sensing signal.

19. The sensing system of claim 18,
wherein the first single period sampling number is larger than the second single period sampling number;
wherein, after the second analog to digital converter generates the second digital sensing signal, the second analog to digital converter does not output the second digital sensing signal until the first analog to digital converter generates the first digital sensing signal.

20. The sensing system of claim 18, wherein the controller is further configured to performs following steps:
detecting device characteristics of the first analog to digital converter and the second analog to digital converter; and
setting the first single period sampling number and the second single period sampling number according to the device characteristics of the first analog to digital converter and the second analog to digital converter.
